(19) United States
(12) Patent Application Publication
(10) Pub. No.: US 2007/0008993 A1
(43) Pub. Date: Jan. 11, 2007

(54) Method for time synchronization in residential Ethernet system

(75) Inventors: Do-Hun Cha, Yongin-si (KR); Jae-Hun Cho, Seoul (KR); Jun-Ho Koh, Suwon-si (KR); Sang-Ho Kim, Hwaseong-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/481,591

(22) Filed: Jul. 6, 2006

(30) Foreign Application Priority Data
Jul. 6, 2005 (KR) 2005-60799

(51) Int. Cl. H04J 3/06

(52) U.S. Cl. 370/509; 370/516

(57) ABSTRACT

Disclosed is a time synchronization method for selecting a predetermined timing master and according Times of Day of a plurality of nodes with a Time of Day of the predetermined timing master in a Residential Ethernet system, which includes the nodes, the method comprising the steps of receiving, by a predetermined node among the nodes, a time value of the predetermined timing master, and setting a time value of the predetermined node as the received time value, and changing, by the predetermined node, the set time value by taking into consideration a data transmission delay time value between the predetermined node and the predetermined timing master.

### CLAIM OF PRIORITY

This application claims the benefit of the earlier filing date, pursuant to under 35 U.S.C. 119(a), of that patent application entitled “Method For Time Synchronization In Residential Ethernet System,” filed in the Korean Intellectual Property Office on Jul. 6, 2005 and assigned Ser. No. 2005-60799, the entire contents of which are incorporated herein by reference.

### BACKGROUND OF THE INVENTION

1. Field of the Invention

The present invention relates to Residential Ethernet, and more particularly to a method for time synchronization between nodes in order to establish “Time of Day” in each node of a Residential Ethernet system.

2. Description of the Related Art

Ethernet is the most widely used local area network technology and is now defined as a standard in an Institute Electrical of Electrical and Electronics Engineers (IEEE) 802.3. Ethernet was been originally developed by Xerox and has been advanced by Xerox, Digital Equipment Corporation (DEC), Intel, etc.

The Ethernet is a technology generally used when data are transmitted among a plurality of terminals or users. In conventional Ethernet, since competitive access is accomplished by means of a carrier sense multiple access/collision detect (CSMA/CD) protocol stipulated in the IEEE 802.3, a service frame of an upper layer is converted to an Ethernet frame, which is transmitted, while maintaining an inter frame gap (IFG). In this case, upper service frames are transmitted according to the creation sequence thereof, regardless of the frame type thereof.

Conventional Ethernet is known to be insufficient for transmitting a moving image or sound data susceptible to transmission delay, as the Ethernet employs the CSMA/CD scheme in which every Ethernet frame is given the same priority and is competitively transmitted.

However, recently, as the transmission of moving images and sound data susceptible to transmission delay has gradually increased and their relative importance in data transmission has become greater, various methods have been proposed for removing such a problem caused by transmission delay in using a conventional Ethernet scheme.

IEEE 802.3p/q is one scheme proposed in order to reduce time delay in the Ethernet. According to the IEEE 802.3p/q, classification of service (COS) is allocated to data such as multimedia data, to which priority must be given. The IEEE 802.3p/q scheme provides a slightly improved effect with respect to time delay by allocating a priority to multimedia data or the like to be transmitted, as compared with the conventional IEEE 802.3 Ethernet scheme. However, since the IEEE 802.3p/q scheme does not employ a procedure of requiring and allocating a bandwidth to each data, a bandwidth manager for managing allocation of the bandwidth is required, thereby increasing the size of a jitter buffer for such bandwidth management.

A Residential Ethernet is another proposed transmission scheme, in which synchronous data and asynchronous data are separately transmitted during one transmission cycle. According to the Residential Ethernet, slots of the same size are respectively allocated to synchronous data, so that sub-synchronous frames having the same size are formed and transmitted.

FIG. 1 is a view illustrating the structure of a transmission cycle in a conventional Residential Ethernet.

The conventional Residential Ethernet currently being discussed has a transmission cycle 10 of 125 μsec for data transmission, and each transmission cycle includes an asynchronous frame section 110 for transmission of asynchronous data and a synchronous frame section 100 for transmission of synchronous data.

In more detail, the synchronous frame section 100 for transmission of synchronous data has the highest priority in the transmission cycle, and includes 738-byte sub-synchronous frames 101, 102, and 103 according to a proposal under the current discussion. Although 738 bytes is currently being discussed, it would be recognized that the number of bytes can be modified without altering the scope of the invention. In addition, the asynchronous frame section 110 for transmission of the asynchronous data includes sub-asynchronous frames 111, 112, and 113 having various lengths in each corresponding area.

In such a conventional Residential Ethernet, every node must possess the same transmission cycle and transmit synchronous data through the synchronous frame section 100 of a corresponding transmission cycle. In order for every node to set a transmission cycle of the same size and to transmit synchronous data through the synchronous frame section 100 of the transmission cycle, the nodes must be synchronized with each other.

In Real-time Ethernet, such as broadcasting, every node must have same “Time of Day” information on the basis of a timing master, in addition to typical bit synchronization. This is because time synchronization between data transmitted from the nodes cannot be achieved if nodes spaced from each other have different time information. Thus, in the case of broadcasting, image and sound might be not synchronized. Also, when events, which have been generated by nodes at the same time point, are reported to a central control apparatus, the events may be reported as if they are generated at different time points if the “Times of Day” of the nodes do not match with each other. In this case, a server, which synthetically judges these events and performs a corresponding control operation, may misjudge that the events have been generated at different time points, because there is no way to recognize that the events have been generated at the same time point.

FIG. 2 is a view for explaining a case in which the “Time of Day” of each node is mismatched in a conventional Residential Ethernet system.

When AN apparatuses are spaced from each other, the AN apparatuses may not be synchronized with each other if the same time information (i.e. Time of Day) is not provided.

For example, a DVD player 21 for reproducing image and sound provides output data 201 including the image and sound.

The output data 201, which includes the image and sound provided are separated into image output data 202 and sound output data 203 through a first switch 22. The sound output data 203 separated through the first switch 22 are reproduced as a sound through an amplifier 23.

Also, the image output data 202 separated through the first switch 22 are transmitted through a second switch 24 to a video apparatus 25, such as a television display screen, a projector, etc., and being reproduced as an image.

In this case, if the Times of Day of the video and audio signals are not in harmony among the DVD player 21, the first switch 22, the second switch 24, the amplifier 23, and the video apparatus 25, which are nodes, the image data 202 output through the video apparatus 25 and the sound data 203 output through the amplifier 23 may not be synchronized.

In addition, in a case in which a plurality of acoustic apparatuses, such as a guitar, an electronic organ, etc., act as nodes, it may be difficult for a server to make music by using data received from the acoustic apparatuses if time synchronization is not achieved between the received data.

For this reason, such time synchronization is raised as a very important matter in Residential Ethernet technology. However, until now, no research has been conducted to develop a time synchronization method taking the Time of Day into consideration in Residential Ethernet. Therefore, particularly, research is required to develop a time synchronization method in relation to a physical layer and data link layer, which is concerned with Residential Ethernet technology.

### SUMMARY OF THE INVENTION

Accordingly, the present invention has been made to meet the above-mentioned requirement and provides additional advantages, by providing a time synchronization method capable of synchronizing the Times of Day of nodes with that of a timing master in Residential Ethernet, which can transmit multimedia data while minimizing time delay and ensuing Quality of Service (QoS).

One aspect of the present invention is to provide a time synchronization method capable of synchronizing “Time of Day” information of nodes in a physical layer and a data link layer on the basis of a timing master.

In one embodiment, there is provided a time synchronization method for selecting a predetermined timing master and according Times of Day of a plurality of nodes with a Time of Day of the predetermined timing master in a Residential Ethernet system, which includes the nodes, the method comprising the steps of receiving, by a predetermined node among the nodes, a time value of the predetermined timing master, and setting a time value of the predetermined node as the received time value, and changing, by the predetermined node, the set time value by taking into consideration a data transmission delay time value between the predetermined node and the predetermined timing master.

### BRIEF DESCRIPTION OF THE DRAWINGS

The above features and advantages of the present invention will be more apparent from the following detailed description taken in conjunction with the accompanying drawings, in which:

FIG. 1 is a view illustrating an exemplary transmission cycle in conventional Residential Ethernet;

FIG. 2 is a view for illustrating a the “Time of Day” mismatch in a conventional Residential Ethernet system;

FIG. 3 is a view illustrating a PTP message frame for achieving time synchronization in Residential Ethernet according to an embodiment of the present invention;

FIG. 4 is a flowchart illustrating the procedure for performing time synchronization in Residential Ethernet according to an embodiment of the present invention; and

FIG. 5 is a timing diagram illustrating the procedure for performing time synchronization in Residential Ethernet according to an embodiment of the present invention.

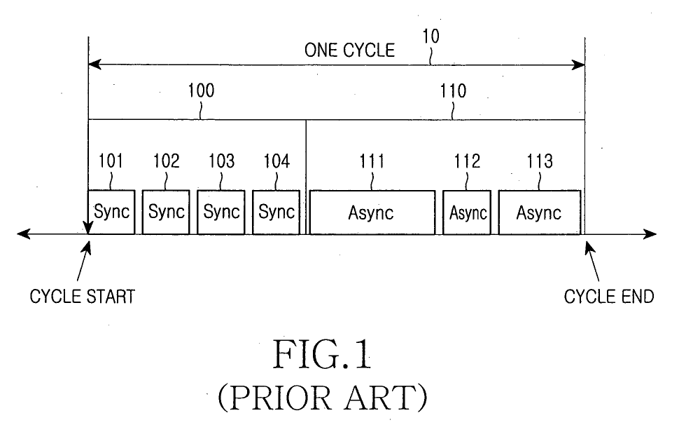

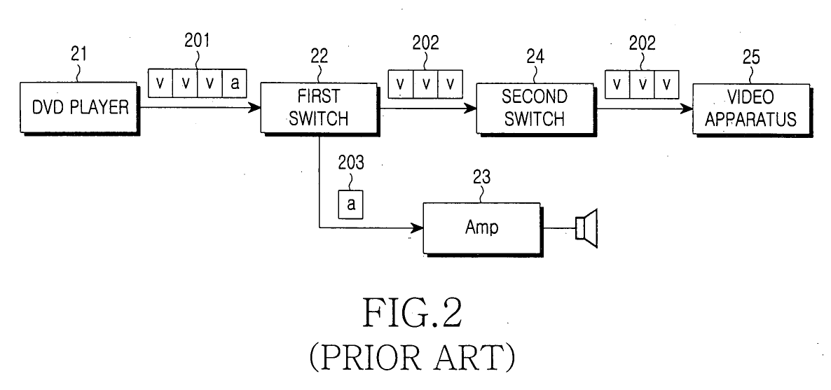

### DETAILED DESCRIPTION OF THE INVENTION

Hereinafter, one preferred embodiment of the present invention will be described with reference to the accompanying drawings. It is to be noted that the same elements are indicated with the same reference numerals throughout the drawings. For the purposes of clarity and simplicity, a detailed description of known functions and configurations incorporated herein will be omitted as it may obscure the subject matter of the present invention.

Generally-used timing protocols include an RFC Simple Network Timing Protocol (SNTP) and an IEEE 1588 protocol. Since the SNTP performs time stamping in an application layer, it is not suitable for the present invention, which performs time synchronization in a physical layer and a data link layer.

Therefore, an embodiment of the present invention will be described by using the IEEE 1588 protocol, which performs a time stamping operation in the physical layer and data link layer. However, it would be recognized by those skilled in the art that the principles of the invention described herein is applicable to other transmission protocols.

In particular, in the following description according to the present invention, a time synchronization method for synchronizing Times of Day among nodes in a Residential Ethernet system by using a precision time protocol (PTP), which is known in the IEEE 1588 protocol, will be described.

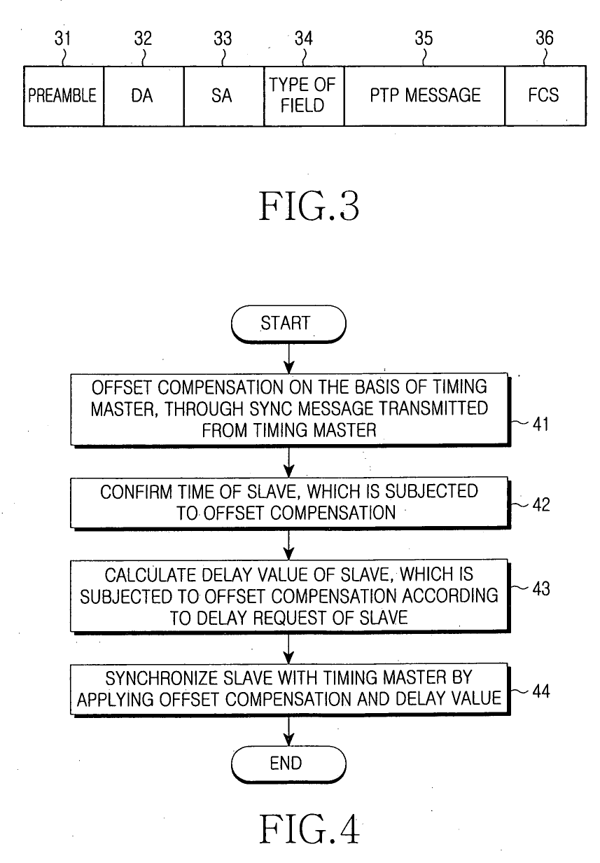

FIG. 3 is a view illustrating the structure of a PTP message frame for achieving time synchronization in Residential Ethernet according to an embodiment of the present invention.

The PTP message frame for the time synchronization in Residential Ethernet according to an embodiment of the present invention includes an 8-byte preamble field 31, a 6-byte destination address (DA) field 32 representing a destination MAC address, a 6-byte source address (SA) field 33 representing a source MAC address, a 2-byte type field 34 defining a type of data, a PTP message field 35 including a PTP message to be transmitted, and a 4-byte FCS field 36 for checking for an error in a transmission frame.

According to an embodiment of the present invention, the PTP message is not accommodated in a user datagram protocol (UDP), but contents of the PTP message are defined by using an undefined region of the type field 34 in an Ethernet frame in order to set time exactly so as to be synchronized. In addition, the PTP message field includes a proper message based on defined contents.

According to an embodiment of the present invention, the PTP message frame is classified into a synchronization message, a follow-up message, a delay request message, and a delay response message. The synchronization message is transmitted from a timing master to nodes in order to start time synchronization, and the follow-up message is transmitted to send time information of the timing master after the synchronization message has been transmitted. The delay request message is transmitted from a node to the timing master in order to establish a delay time caused by a corresponding network, after time has been accorded between the node and the timing master. In addition, the delay response message is transmitted from the timing master in response to the delay request message.

The PTP messages as described above are processed in a media independent interface (MII) region between a MAC layer and the physical layer. In particular, a time stamp unit (TSU) of the MII region detects a synchronization time, a delay request sending time, a receipt time in response to a delay request, which are read from PTP message frames of the synchronization message, follow-up message, etc., in such a manner that a corresponding node can control them through a controller (CPU). In this case, each read time is based on a time point at which a last bit of a starting frame delimiter (SFD) region in the preamble field 31 of an Ethernet frame is transmitted.

FIG. 4 is a flowchart illustrating the procedure for performing time synchronization in Residential Ethernet according to an embodiment of the present invention.

In a Residential Ethernet system, which includes a plurality of nodes and in which a timing master is selected, the time synchronization method for comparing Times of Day information of the nodes with that of the timing master based on the present invention is performed through two operations.

According to the first operation, the time values of the nodes and the timing master are set to the same value. In order to set time values of the nodes and a time value of the timing master to have the same value, each node receives the time value of the timing master from the timing master and sets the time value of the node to be the time value of the timing master.

According to the second operation, an offset adjustment is performed in consideration of a delay caused by a network environment between the timing master and each node, which has performed the first operation, with respect to the node.

First, according to the first operation, each node (hereinafter, referred to as a “slave” representing a relative counterpart of the timing master) receives a synchronization message for starting time synchronization from the timing master, checks time information of the timing master through a follow-up message following the synchronization message, and compensates for a time offset of the slave on the basis of the time value of the timing master (step 41).

Then, the slave compares its own time value, which has been compensated for the time offset, with the time value of the timing master, thereby checking if the time of the slave is identical to the time of the timing master (step 42). Herein, the time comparison between the slave and the timing master is performed by checking a synchronization message, which is periodically transmitted, and a follow-up message following the synchronization message.

After the first operation has been performed through the above-mentioned procedure, an offset adjustment which takes a delay environment into consideration is performed as follows.

First, in order to perform an offset adjustment which takes a delay environment into consideration, the slave sends a delay request message to the timing master so as to calculate a delay value of the slave, the time value of which has been compensated (step 43). The timing master sends a delay response message in response to the delay request message of the slave. Then, time information included in the delay response message is used to calculate a delay value. That is, a difference between a time value of the delay request and a time value of the delay response is divided by two, thereby obtaining a delay value.

Since the operations of the time synchronization method according to the present invention are performed in the physical layer and data link layer, a processing delay rarely occurs, so that the above-mentioned processing is possible. Therefore, the time synchronization method according to an embodiment of the present invention is designed such that a processing delay is ignored and only a transmission delay in a network is considered.

Such a delay value and an time value offset-compensated through the first operation are both applied to the time value of the slave, so that the time value of the slave can be synchronized with the time value of the timing master (step 44).

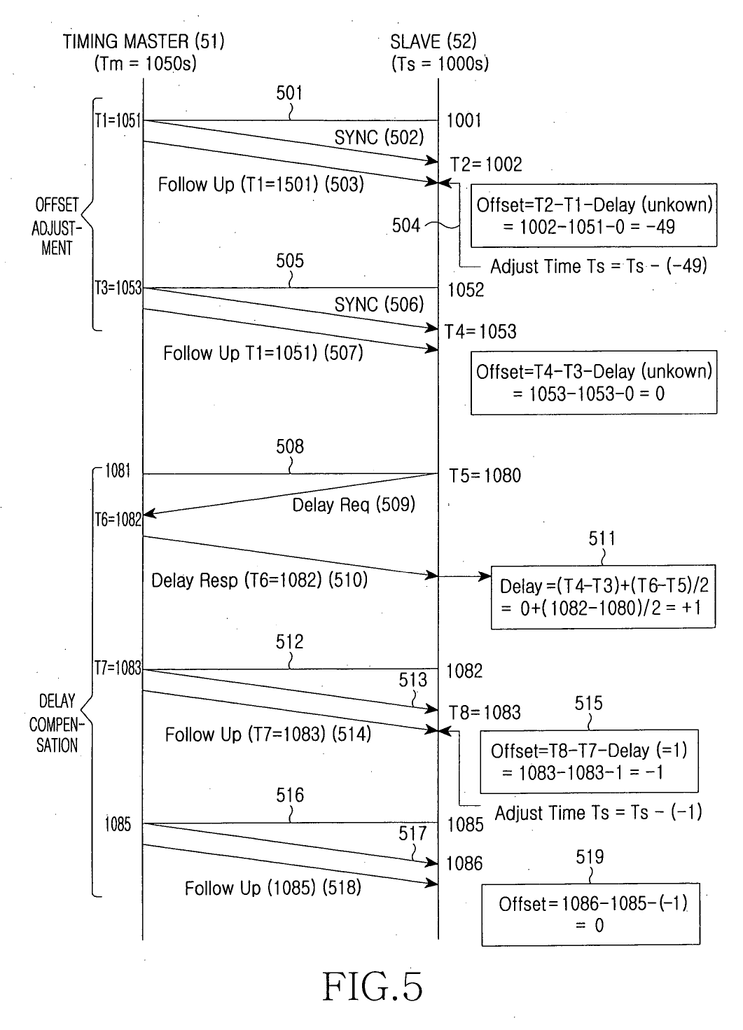

FIG. 5 is a timing diagram illustrating the procedure for performing time synchronization in Residential Ethernet according to an embodiment of the present invention.

The time synchronization method shown in FIG. 4 according to an embodiment of the present invention will now be described in detail with reference to the timing diagram of FIG. 5.

Basically, a time offset between a timing master 51 and a slave 52 is established in Equation 1.
Time Offset=Time of Slave−Time of Time Master (1)

Initial set time values of the timing master 51 and slave 52 are “Tm=1050s” and “Ts=1000s”, respectively.

At a time point of “Tm=1051s” in the timing master 51 (step 501), when the timing master 51 transmits a first synchronization message to the slave 52 (step 502), the time value of “Tm=1051s” corresponding to the first synchronization message is transmitted to the slave 52 through a first follow-up message (step 503).

Then, the time offset is determined by Equation 1 (step 504). In this case, since a delay time has not known, the delay time is set at an initial value of “0”.

Therefore, through such a procedure for equalizing the time value of the slave 52 to the time value of the timing master 51, parameters of Equation 1 are determined, except for the value of a delay time. In this case, since the time value of the slave 52 becomes equal to the time value of the timing master 51 through the first operation, it is determined that the time offset corresponds to the delay time.

Then, in order to determine if the time value of the slave 52 is equal to the time value of the timing master 51, a second synchronization message is transmitted at a time point established in step 505 (step 506), that is, at a time point “Tm=1053s” of the timing master 51 and at a time point of “Ts=1052s” the slave 52. Then, it can be confirmed through a second follow-up message following the second synchronization message that the slave 52 and the timing master 51 have been equalized with each other (step 507).

Thereafter, according to the an offset compensation procedure taking a delay environment into consideration, which is the second operation, a delay request message is transmitted from the slave 52 to the timing master 51 at a time established in step 508, at which an offset due to a delay environment has not been compensated for (step 509). When such a delay request message is transmitted, time information (T5=1080) on the time at which the delay request message is transmitted is stored in the slave 52.

Then, the timing master 51 transmits a delay response message in response to the delay request message (step 510). In this case, the delay response message includes time information about a time point (T6=1082), at which the timing master 51 transmits the delay response message.

Thereafter, a delay time value is calculated using Equation 2.
Delay Time Value=(Time of Time Master upon transmittig Synchronization message−Time of Slave upon receiving Synchronization message)+(Time of Delay response message−Time of Delay request message)/2 (2)

Herein, since it has been confirmed through the first operation (steps 501 to 507) that the time value of the timing master 51 upon transmitting a synchronization message is equal to the time value of the slave 52 upon receiving the synchronization message, the term “Time of Timing master upon transmitting Synchronization Message−Time of Slave upon receiving Synchronization Message” in Equation 2 has a value of “0”.

When the remaining terms are calculated according to an embodiment of the present invention, the delay time value becomes “(1082-1080)/2=1”.

Accordingly, when another synchronization message is transmitted (step 513), the delay time value obtained through the above steps is applied to determine a time offset by Equation 1 (steps 513 to 515).

Thereafter, the same confirmation procedure as that described above is performed (steps 516 to 519).

As described above, according to the present invention, time synchronization for each node is performed in the physical layer and data link layer through the PTP algorithm in Residential Ethernet, so that it is possible to synchronize the Time of Day of each node with that of the timing master in Residential Ethernet, which can transmit multimedia data while minimizing time delay and ensuing Quality of Service (QoS).

The above-mentioned methods and apparatus according to the present can be realized in hardware or as software or computer code that can be stored in a recording medium such as a CD ROM, an RAM, a floppy disk, a hard disk, or a magneto-optical disk or downloaded over a network, so that the method described herein can be executed by such software using a general purpose computer, or a special processor or in programmable or dedicated hardware, such as an ASIC or FPGA.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A time synchronization method for selecting a predetermined timing master and according Times of Day of a plurality of nodes with a Time of Day of the predetermined timing master in a Residential Ethernet system, which includes the nodes, the method comprising the steps of:
a) receiving, by a predetermined node among the nodes, a time value of the predetermined timing master, and setting a time value of the predetermined node as the received time value; and
b) changing, by the predetermined node, the set time value by taking into consideration a data transmission delay time value between the predetermined node and the predetermined timing master.

2. The method as claimed in claim 1, wherein the step of receiving comprising the steps of:
receiving, by the predetermined node, a synchronization message periodically-transmitted from the predetermined timing master in order to perform time synchronization;
receiving a time value, at which the predetermined timing master transmits the synchronization message, through a follow-up message following the synchronization message; and
setting a time value of the predetermined node as the received time value.

3. The method as claimed in claim 1, wherein the step of changing comprising the steps of:
transmitting, by the predetermined node, a delay request message to the predetermined timing master, and storing a corresponding delay request time value;
receiving a delay response message from the predetermined timing master in response to the delay request message;
determining a data transmission delay time value for a delay between the predetermined node and the predetermined timing master by using the delay request time value and time information included in the delay response message; and
changing the time value by applying the determined data transmission delay time value to the set time value.

4. The method as claimed in claim 1, wherein the synchronization message, the follow-up message, the delay request message, and the delay response message are based on a precision time protocol (PTP).

5. The method as claimed in claim 4, wherein the PTP messages are formed through an Ethernet frame for precision of time to be synchronized without accommodating the PTP messages in a user datagram protocol (UDP).

6. The method as claimed in claim 4, wherein the PTP messages are processed in a media independent interface (MII) region between a MAC layer and a physical layer in the predetermined node.

7. An apparatus for selecting a predetermined timing master and according Times of Day of a plurality of nodes with a Time of Day of the predetermined timing master in a Residential Ethernet system, which includes the nodes, comprising:
a memory containing code for providing instruction to a processor to execute the steps of:
a) receiving, by a predetermined node among the nodes, a time value of the predetermined timing master, and setting a time value of the predetermined node as the received time value; and
b) changing, by the predetermined node, the set time value by taking into consideration a data transmission delay time value between the predetermined node and the predetermined timing master.

8. The apparatus as claimed in claim 7, wherein the step of receiving comprising the steps of:
receiving, by the predetermined node, a synchronization message periodically-transmitted from the predetermined timing master in order to perform time synchronization;
receiving a time value, at which the predetermined timing master transmits the synchronization message, through a follow-up message following the synchronization message; and
setting a time value of the predetermined node as the received time value.

9. The apparatus as claimed in claim 7, wherein the step of changing comprising the steps of:
transmitting, by the predetermined node, a delay request message to the predetermined timing master, and storing a corresponding delay request time value;
receiving a delay response message from the predetermined timing master in response to the delay request message;
determining a data transmission delay time value for a delay between the predetermined node and the predetermined timing master by using the delay request time value and time information included in the delay response message; and
changing the time value by applying the determined data transmission delay time value to the set time value.

10. The apparatus as claimed in claim 8, wherein the synchronization message, the follow-up message, the delay request message, and the delay response message are based on a precision time protocol (PTP).

11. The apparatus as claimed in claim 10, wherein the PTP messages are formed through an Ethernet frame for precision of time to be synchronized without accommodating the PTP messages in a user datagram protocol (UDP).

12. The apparatus as claimed in claim 10, wherein the PTP messages are processed in a media independent interface (MII) region between a MAC layer and a physical layer in the predetermined node.
